(19) United States
(12) Patent Application Publication
(10) Pub. No.: US 2025/0253914 A1
(43) Pub. Date: Aug. 7, 2025

(54) BEAM MANAGEMENT

(71) Applicant: Nokia Technologies Oy, Espoo (FI)

(72) Inventors: Simon SVENDSEN, Aalborg (DK); Christian ROM, Aalborg (DK); Sami-Jukka HAKOLA, Oulu (FI); Juha Pekka KARJALAINEN, Oulu (FI); Mihai ENESCU, Espoo (FI)

(21) Appl. No.: 18/695,292

(22) PCT Filed: Oct. 14, 2021
(86) PCT No.: PCT/EP2021/078539

§ 371 Date: Mar. 25, 2024

(51) Int. Cl. H04B 7/06

(52) U.S. Cl. CPC H04B 7/0695

(57) ABSTRACT

Examples of the disclosure relate to beam management within networks comprising User Equipments (UEs) that can be configured to receive power from different beams. The UEs can be configured to receive information indicative of at least one expanded transmission configuration from a node apparatus. The expanded transmission configuration comprises a primary beam configuration and a secondary beam configuration wherein the primary beam configuration and the secondary beam configuration comprise different angular areas from which the UE receives power from the node apparatus. The UE is also configured so that, in response to receiving the information indicative of the at least one expanded transmission configuration, the UE is enabled to use the primary beam configuration and/or the secondary beam configuration to receive signals from the node apparatus.

### TECHNOLOGICAL FIELD

Examples of the disclosure relate to beam management. Some relate to beam management within networks comprising User Equipments (UEs) that can be configured to receive power from different beams.

### BACKGROUND

Beam management can be used to reduce losses between a UE and access nodes such as a Base Station (gNB). Beam management can provide for improved alignment of beams between the UE and the access nodes.

### BRIEF SUMMARY

According to various, but not necessarily all, examples of the disclosure there may be provided a User Equipment (UE) comprising:
at least one processor; and
at least one memory including computer program code
the at least one memory and the computer program code configured to, with the at least one processor, cause the UE at least to perform:
receiving information indicative of at least one expanded transmission configuration from a node apparatus wherein the expanded transmission configuration comprises a primary beam configuration and a secondary beam configuration wherein the primary beam configuration and the secondary beam configuration comprise different angular areas from which the UE receives power from the node apparatus; and
in response to receiving the information indicative of the at least one expanded transmission configuration enabling the UE to use the primary beam configuration and/or the secondary beam configuration to receive signals from the node apparatus.

The information indicative of the at least one expanded transmission configuration may be received in response to a report transmitted by the UE indicating at least the primary beam configuration and an availability of one or more secondary beam configurations.

The transmitted report may indicate one or more beam configurations that the UE has determined to be receiving power above a threshold level.

The primary beam configuration may make use of a Primary-Angular Power Area (P-APA) and the secondary beam configuration makes use of a Secondary Useable-Angular Power Area (SU-APA) wherein an angular power area comprises a range of angular directions from which the UE is receiving power from the node apparatus.

The at least one expanded transmission configuration may be indicated by using one or more bits in a pre-agreed structure within a message.

The at least one expanded transmission configuration may comprise an indication of a cell and a bandwidth part.

The at least one expanded transmission configuration may enable the node apparatus to transmit Downlink (DL) signals.

The at least one expanded transmission configuration may enable the UE to receive signals based on one or more Quasi Co-Location (QCL) assumptions.

The at least one expanded transmission configuration may comprise one or more Transmission Configuration Indicator (TCI) states.

According to various, but not necessarily all, examples of the disclosure there may be provided a method comprising:
receiving information indicative of at least one expanded transmission configuration from a node apparatus wherein the expanded transmission configuration comprises a primary beam configuration and a secondary beam configuration wherein the primary beam configuration and the secondary beam configuration comprise different angular areas from which the UE receives power from the node apparatus; and
in response to receiving the information indicative of the at least one expanded transmission configuration enabling the UE to use the primary beam configuration and/or the secondary beam configuration to receive signals from the node apparatus.

According to various, but not necessarily all, examples of the disclosure there may be provided a computer program comprising computer program instructions that, when executed by processing circuitry, cause:
receiving information indicative of at least one expanded transmission configuration from a node apparatus wherein the expanded transmission configuration comprises a primary beam configuration and a secondary beam configuration wherein the primary beam configuration and the secondary beam configuration comprise different angular areas from which the UE receives power from the node apparatus; and
in response to receiving the information indicative of the at least one expanded transmission configuration enabling the UE to use the primary beam configuration and/or the secondary beam configuration to receive signals from the node apparatus.

According to various, but not necessarily all, examples of the disclosure there may be provided a User Equipment (UE) comprising means for:
receiving information indicative of at least one expanded transmission configuration from a node apparatus wherein the expanded transmission configuration comprises a primary beam configuration and a secondary beam configuration wherein the primary beam configuration and the secondary beam configuration comprise different angular areas from which the UE receives power from the node apparatus; and
in response to receiving the information indicative of the at least one expanded transmission configuration enabling the UE to use the primary beam configuration and/or the secondary beam configuration to receive signals from the node apparatus.

According to various, but not necessarily all, examples of the disclosure there may be provided a node apparatus comprising:
at least one processor; and
at least one memory including computer program code, the at least one memory and the computer program code configured to, with the at least one processor, cause the node apparatus at least to perform:
receiving a report from a User Equipment (UE) indicating at least a primary beam configuration and an availability of one or more secondary beam configurations wherein the primary beam configuration and the secondary beam configuration comprise different angular areas from which the UE receives power from the node apparatus; and
in response to receiving the report enabling at least one expanded transmission configuration based, at least in part, on the availability of the one or more secondary beam configurations wherein the expanded transmission configuration comprises the primary beam configuration and a secondary beam configuration.

The received report may indicate one or more beam configurations that the UE has determined to be receiving power above a threshold level.

The primary beam configuration may make use of a Primary-Angular Power Area (P-APA) and the secondary beam configuration makes use of a Secondary Useable-Angular Power Area (SU-APA) wherein an angular power area comprises a range of angular directions from which the UE is receiving power from the node apparatus.

The at least one processor and at least one memory may be configured to perform transmitting information indicative of the at least one expanded transmission configuration to the UE.

The at least one expanded transmission configuration may be indicated by using one or more bits in a pre-agreed structure within a message.

The at least one expanded transmission configuration may comprise an indication of a cell and a bandwidth part.

The at least one expanded transmission configuration may enable the node apparatus to transmit Downlink (DL) signals.

The at least one expanded transmission configuration may enable the UE to receive signals based on one or more Quasi Co-Location (QCL) assumptions.

The at least one expanded transmission configuration may comprise one or more Transmission Configuration Indicator (TCI) states.

The at least one expanded transmission configuration may be enabled based on one or more requirements of the node apparatus.

According to various, but not necessarily all, examples of the disclosure there may be provided a method comprising:
receiving a report from a User Equipment (UE) indicating at least a primary beam configuration and an availability of one or more secondary beam configurations wherein the primary beam configuration and the secondary beam configuration comprise different angular areas from which the UE receives power from the node apparatus; and
in response to receiving the report enabling at least one expanded transmission configuration based, at least in part, on the availability of the one or more secondary beam configurations wherein the expanded transmission configuration comprises the primary beam configuration and a secondary beam configuration.

According to various, but not necessarily all, examples of the disclosure there may be provided a computer program comprising computer program instructions that, when executed by processing circuitry, cause:
receiving a report from a User Equipment (UE) indicating at least a primary beam configuration and an availability of one or more secondary beam configurations wherein the primary beam configuration and the secondary beam configuration comprise different angular areas from which the UE receives power from the node apparatus; and
in response to receiving the report enabling at least one expanded transmission configuration based, at least in part, on the availability of the one or more secondary beam configurations wherein the expanded transmission configuration comprises the primary beam configuration and a secondary beam configuration.

According to various, but not necessarily all, examples of the disclosure there may be provided a node apparatus comprising means for:
receiving a report from a User Equipment (UE) indicating at least a primary beam configuration and an availability of one or more secondary beam configurations wherein the primary beam configuration and the secondary beam configuration comprise different angular areas from which the UE receives power from the node apparatus; and
in response to receiving the report enabling at least one expanded transmission configuration based, at least in part, on the availability of the one or more secondary beam configurations wherein the expanded transmission configuration comprises the primary beam configuration and a secondary beam configuration.

### BRIEF DESCRIPTION

Some examples will now be described with reference to the accompanying drawings in which:

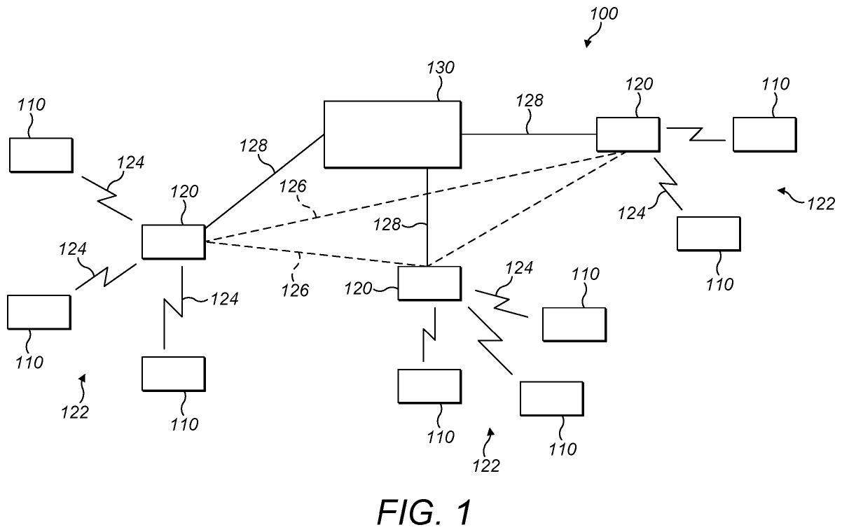

FIG. 1 shows an example network;

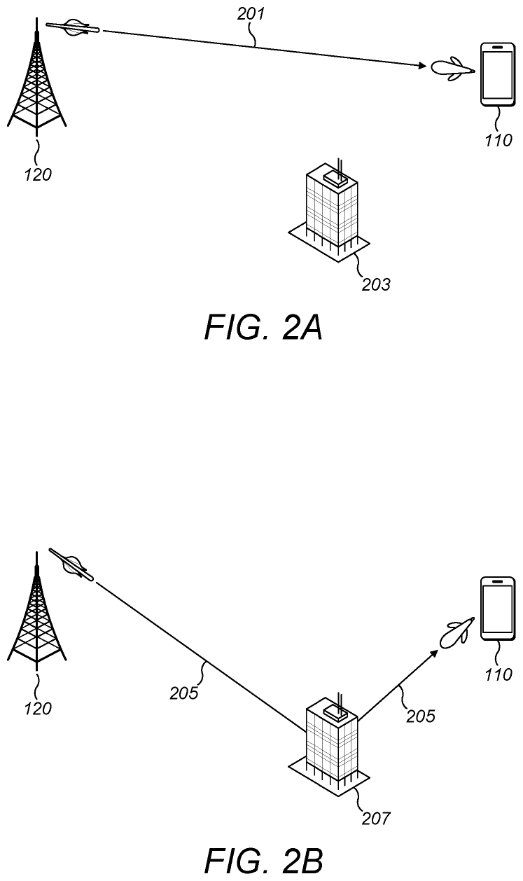

FIGS. 2A and 2B shows example TCI-states

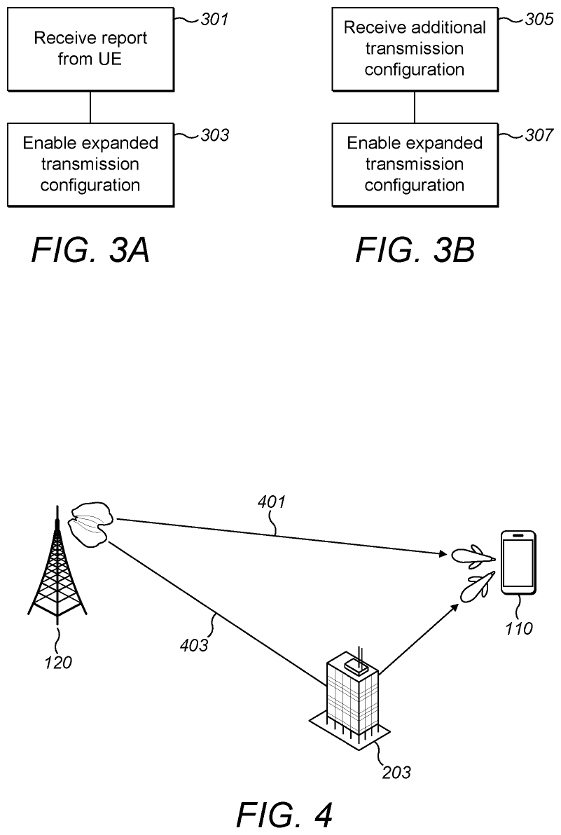

FIGS. 3A and 3B show example methods;

FIG. 4 shows an example expanded TCI-state

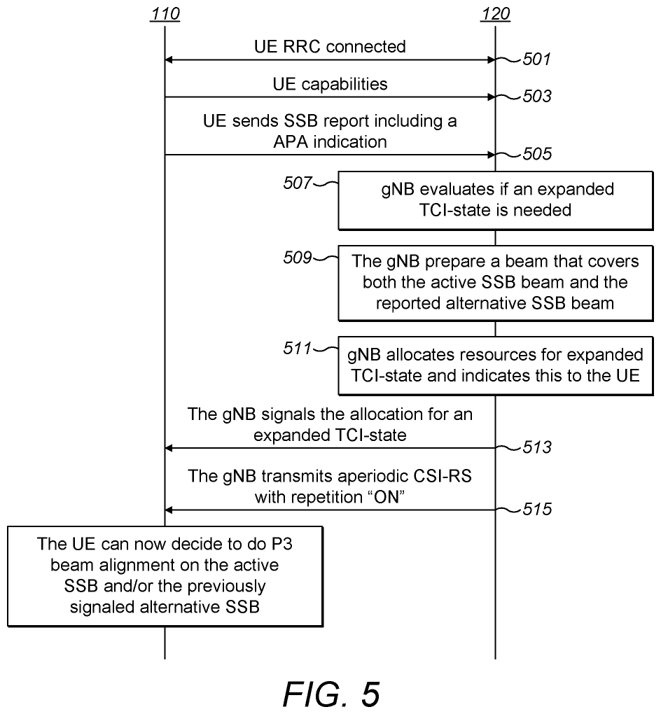

FIG. 5 shows an example signaling chart;

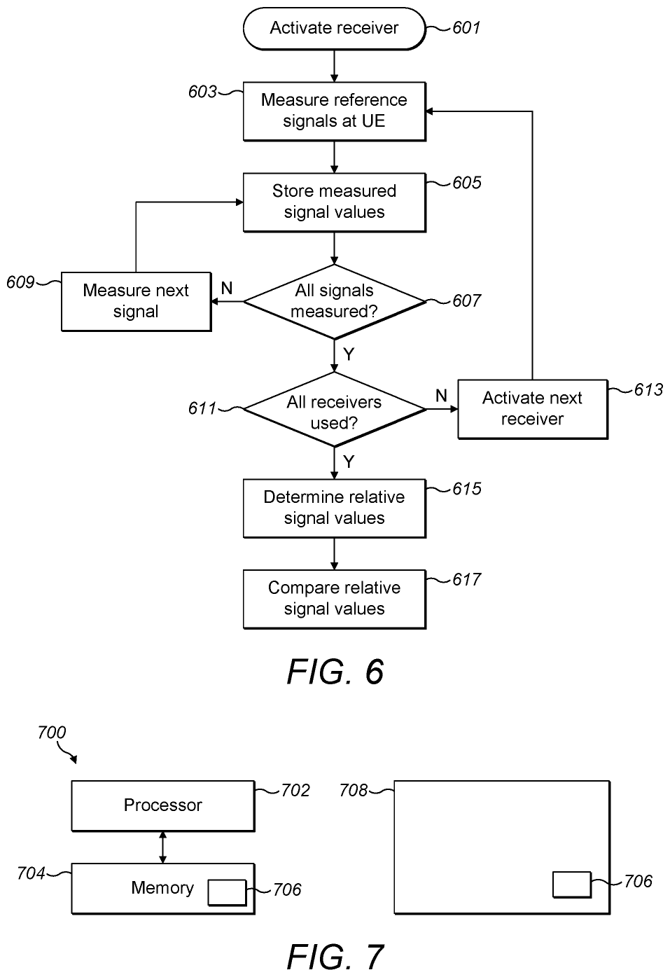

FIG. 6 shows an example method for determining availability of SU-APAs;

FIG. 7 shows an example controller.

### DEFINITIONS

CQI Channel Quality Indicator
CSI Channel State Information
CSI RS CSI Reference Signal
DCI Downlink Control Information
DL Downlink
FSPL Free Space Path Loss
GBBR Group Based beam Reporting
gNB NR Base Station
NZP Non Zero Power
PDCCH Physical Downlink Control Channel
PDSCH Physical Downlink Shared Channel
QCL Quasi Co-Location
RRC Radio Resource Control
RS Reference Signal
RSRP Reference Signal Received Power
RX Receiving
SSB Synchronisation Signal Block
TC Transmission Configuration Indicator
TX Transmitting
UE User Equipment

### DETAILED DESCRIPTION

FIG. 1 illustrates an example of a network 100 comprising a plurality of network nodes including terminal nodes 110, access nodes 120 and one or more core nodes 130. The terminal nodes 110 and access nodes 120 communicate with each other. The one or more core nodes 130 communicate with the access nodes 120.

The one or more core nodes 130 can, in some examples, communicate with each other. The one or more access nodes 120 can, in some examples, communicate with each other.

The network 100 may be a cellular network comprising a plurality of cells 122 each served by an access node 120. In this example, the interface between the terminal nodes 110 and an access node 120 defining a cell 122 is a wireless interface 124.

The access node 120 comprises a cellular radio transceiver. The terminal nodes 110 comprise a cellular radio transceiver.

In the example illustrated the cellular network 100 is a third generation Partnership Project (3GPP) network in which the terminal nodes 110 are user equipment (UE) and the access nodes 120 are base stations.

In the particular example illustrated the network 100 is a Universal Terrestrial Radio Access network (UTRAN). The UTRAN consists of UTRAN NodeBs 120, providing the UTRA user plane and control plane (RRC) protocol terminations towards the UE 110. The NodeBs 120 are interconnected with each other and are also connected by means of the interface 128 to the Mobility Management Entity (MME) 130.

The term ‘user equipment’ is used to designate mobile equipment comprising a smart card for authentication/encryption etc such as a subscriber identity module (SIM). In other examples the term ‘user equipment’ is used to designate mobile equipment comprising circuitry embedded as part of the user equipment for authentication/encryption such as software SIM.

The NodeB can be any suitable base station. A base station is an access node 120. It can be a network element in radio access network responsible for radio transmission and reception in one or more cells to or from the user equipment.

The UTRAN can be a 4G or 5G network, for example. It can for example be a New Radio (NR) network that uses gNB or eNB as access nodes 120. New radio is the 3GPP name for 5G technology.

Such networks 100 can also comprise next generation mobile and communication network, for example, a 6G network.

The access nodes 120 can have different transmission configurations. These different transmission configurations can be defined by beams or spatial filters that are used by the access nodes 120 and the UEs 110. In some examples the different transmission configurations can enable the UEs 110 to receive signals from different angular areas.

A Transmission Configuration Indicator-State (TCI-State) can indicate a transmission configuration between an access node 120 and a UE 110. The TCI-State can be defined by the access node 120 when the UE 110 is in Radio Resource Control (RRC) connected mode. A TCI state can comprise the identity of the relevant cell and Bandwidth part. The TCI State can also specify the relevant Synchronisation Signals (SS)/Physical Broadcast Channel (PBCH) Block or Channel State Information (CSI)

Reference Signal, and the relevant Quasi Co-Location (QCL) Type.

The network 100 can be configured so that a pool comprising of up to 64 TCI-states can be configured for Physical Downlink Control Channel (PDCCH). The network 100 can be configured so that eight of these can be active (Physical Downlink Shared Channel (PDSCH) Medium Access Control-Control Element (MAC-CE)) at the same time.

In order to select TCI-States it is useful for the access node 120 to obtain information about the beam configurations that are being received by the UE 110. It can be useful for the access node 120 to obtain information about different angular areas that the UE 110 is receiving power from. This could be used to enable the access node 120 to switch beam configurations. For instance, if a primary beam configuration makes use of a first angular area and there is a blockage in this area then the access node 120 could be configured to switch to a secondary beam configuration that uses a different angular area. In such examples the access node 120 could update the TCI-state to make use of the different angular area for receiving power.

FIGS. 2A and 2B show example TCI-states. FIGS. 2A and 2B show an access node 120 and a UE 110. The access node and the UE 110 could be part of a network 100 such as the network 100 of FIG. 1. The UE 110 could be a smartphone or any other suitable type of UE 110. The access node 120 could be a gNB or any other suitable type of access node 120.

FIGS. 2A and 2B show two alternative TCI-states that can be maintained by the access node 120. In both of these examples the access node 120 is configured to transmit using a narrow beam configuration and the UE 110 is configured to receive using a narrow beam configuration. In these examples the access node 120 transmits using a P2 configuration and the UE 110 receives using a P3 configuration.

P2 and P3 are processes that are used for beam management. The process P1 is used for beam selection to find the best SSB (wide) beam transmitted by the access node 120. The process P2 is used for beam refinement at the access node 120 to find the best CSI (narrow) beam that is transmitted by the access node 120. The Process P3 is used for beam refinement at the UE 110 to find the best narrow beam used by the UE 110 for reception.

FIG. 2A shows a primary TCI-state 201. In the example of FIG. 2A the beam from the access node 120 is transmitted directly from the access node 120 to the UE 110. There are no reflections or changes of direction of the beam between the transmission of the beam by the access node 120 and the reception of the beam by the UE 110. There is a building 203 located between the access node 120 and the UE 110 but in this example, there are no reflections from the building 203.

This beam that is transmitted directly to the UE 110 provides a primary TCI-state 201. The beam that is used to provide the primary TCI-state has a beam direction and a beam width. This covers an Angular Power Area (APA) at the UE 110.

An APA can comprise a range of directions from which a UE 110 can receive power from an access node 120. An APA can comprise an angular range comprising a direction of arrival of one or more signals. An APA does not need to be defined precisely or in absolute values or angular ranges. A UE 110 can identify different APAs without needing to determine the actual angle of arrival of any of the signals in the APA.

FIG. 2B shows a secondary TCI-state 205. In the example of FIG. 2B the beam from the access node 120 is reflected from the building 203 towards the UE 110. Due to the reflection from the building 203 the UE 110 receives less power using the secondary TCI-state 205 than using the primary TCI-state 201. The Secondary TCI-state 205 can be received from a different APA to the Primary TCI-state 201.

The APA from which the UE 110 receives the primary TCI-state 201 can provide a Primary-APA (P-APA) and the APA from which the UE 110 receives the secondary TCI-state 205 can provide a Secondary Useable-APA (SU-APA).

In the examples of FIGS. 2A and 2B the access node 120 can be configured so that the access node 120 can switch between using the Primary TCI-state 201 at a first time and using the Secondary TCI-state 205 at a second time. This requires the access node 120 to make resources available for both the Primary TCI-state 201 and the Secondary TCI-state 205. This can also lead to invalid TCI-states if the coherence time of the channel between the access node 120 and the UE 110 is low. In many cases the resources used to maintain the Secondary TCI-state 205 would be wasted if the alternative link is not needed. For example, if the changes in the channel conditions are favorable to the Primary TCI-state 201 the access node 120 might never need to make use of the Secondary TCI-state 205 then any resources allocated to this will have been wasted.

Examples of the disclosure reduce the resources used to maintain the secondary TCI-state by enabling an expanded TCI-state to be configured. In examples of the disclosure the expanded TCI-state is enabled in response to the access node 120 receiving a report from a UE 110 indicating that the UE 110 can receive power from a direction or APA other than the direction or APA of the primary TCI-state 201. In some examples of the disclosure the expanded TCI-state is enabled in response to the access node 120 receiving a report from a UE 110 indicating that the UE 110 can receive power from an SU-APA.

FIGS. 3A and 3B show example methods that can be performed by a UE 110 and an access node 120. These methods can be performed if a UE 110 has identified that it can receive signals from different access node 120 beam configurations where the different access node 120 beam configurations cover different angular areas. For example, the UE 110 can determine that the UE 110 can receive power from an SU-APA. In such cases a primary transmission configuration, such as a primary TCI-state, could make use of the P-APA. The signals that are received by the SU-APA can be used to enable an expanded transmission configuration using a secondary beam configuration or secondary TCI-state at the access node 120.

FIG. 3A shows an example method that could be performed by a node apparatus. The node apparatus could be an access node 120 or a controller within an access node 120 or any other suitable apparatus. The access node 120 could be configured to communicate with the UE 110 in a network 100 such as the network shown in FIG. 1 or any other suitable type of network.

The method comprises, at block 301, receiving a report from a UE 110. The report indicates at least a primary beam configuration and an availability of one or more secondary beam configurations that can be used by the UE 110 to receive power from the access node 120. The primary beam configuration and the secondary beam configuration comprise different angular areas from which the UE receives power from the node apparatus or access node 120.

For example, the report can indicate that the UE 110 can receive power from a P-APA and also from one or more SU-APAs. The UE 110 can use the received power levels of reference signals from the access node 120 to identify the P-APA and any SU-APAs. FIG. 6 shows an example method that can be used to identify the P-APA and any SU-APAs. Other methods could be used in other examples of the disclosure.

The report that is received at block 301 can indicate one or more beam configurations that the UE 110 has determined to be receiving power above a threshold level. For example, only reference signals that are above a threshold power can be considered to be received from an SU-APA. The threshold power level could be set by the access node 120 or any other suitable network entity.

In response to receiving the report, the method comprises, at block 303, enabling at least one expanded transmission configuration. The expanded beam configuration comprises both the primary beam configuration and the secondary beam configuration. The expanded beam configuration covers the angular areas of both the primary beam configuration and the secondary beam configuration.

The expanded transmission configuration is enabled based, at least in part, on the availability of the one or more secondary beam configurations as indicated in the report. The expanded transmission configuration will only be enabled if the report provides an indication of at least one secondary beam configuration.

The access node 120 can also decide whether or not to enable the expanded transmission configuration based on other criteria. The other criteria could comprise reliability and robustness requirements, current channel conditions and other suitable factors. For instance, if the access node 120 is performing applications that require high reliability then expanded transmission configuration can be configured. Whereas if the access node 120 is performing applications that require resources to be minimised the access node 120 could ignore the information relating to the availability of one or more secondary beam configurations and can continue to use just the primary transmission configuration.

The primary beam configuration can be configured to make use of the P-APA and the secondary beam configuration makes use of the SU-APA. The P-APA and the SU-APA can comprise different angular directions. The different angular directions can be such that a blockage or obstruction that affects the P-APA might not affect the SU-APA.

In some examples the at least one expanded transmission configuration can comprise an indication of a cell and a bandwidth part. The at least one expanded transmission configuration can enable the access node 120 to transmit Downlink (DL) signals using either the primary beam configuration or the secondary beam configuration. The at least one expanded transmission configuration can enable the UE 110 to receive signals based on one or more QCL assumptions.

The at least one expanded transmission configuration can comprise one or more TCI-states or any other suitable type of transmission configurations.

When the expanded transmission configuration has been enabled the node apparatus 120 can be configured to enable information indicative of the at least one expanded transmission configuration to be transmitted to the UE 110. The expanded transmission configuration can be indicated using any suitable means. In some examples the at least one expanded transmission configuration can be indicated by using one or more bits in a pre-agreed structure within a message.

In some examples the expanded transmission configuration can be indicated by adding data to a CSI-ResourceConfig message or any other suitable message. For instance, where the expanded transmission configuration comprises an expanded TCI-state then a bit can be added to the CSI-ResourceConfig with the following meaning:
0 indicates No expanded TCI-state for aperiodic Non Zero Power (NZP)-CSI-RS with repetition ON
1 indicates Expanded TCI-state for aperiodic NZP-CSI-RS with repetition ON

In such examples the TCI-states can be configured by the access node 120 and updated using a Downlink Control Information (DCI) message. Information regarding the use of a transmission configuration could be added to either the NZP-CSI-RS-ResourceSet sequence, the NZP-CSI-RS-Resource sequence or the TCI-stateID sequence, or any other suitable message. Examples of such messages are as follows:

NZP-CSI-RS-ResourceSet ::= SEQUENCE {

| nzp-CSI-ResourceSetId | NZP-CSI-RS-ResourceSetId, | |
|---|---|---|
| nzp-CSI-RS-Resources | SEQUENCE (SIZE (1..maxNrofNZP-CSI-RS- | |
| | ResourcesPerSet)) OF NZP-CSI-RSResourceId, | |
| repetition | ENUMERATED { on, off } | OPTIONAL, |
| Expanded TCI-State | BIT STRING (SIZE (1)) | OPTIONAL, |
| aperiodicTriggeringOffset | INTEGER(0..4) | OPTIONAL, |
| trs-Info | ENUMERATED {true} | OPTIONAL, |

...
}
NZP-CSI-RS-Resource ::= SEQUENCE {

| | | |
|---|---|---|
| nzp-CSI-RS-ResourceId | NZP-CSI-RS-ResourceId, | |
| resourceMapping | CSI-RS-ResourceMapping, | |
| powerControlOffset | INTEGER (−8..15), | |
| powerControlOffsetSS | ENUMERATED{db-3, db0, db3, db6} | OPTIONAL, |
| | -- Need R | |
| scramblingID | ScramblingId, | |
| periodicityAndOffset | CSI-ResourcePeriodicityAndOffset | OPTIONAL,- |
| qcl-InfoPeriodicCSI-RS | TCI-StateId | OPTIONAL, |
| -- Cond Periodic | | |
| Expanded TCI-State | BIT STRING (SIZE (1)) | OPTIONAL, |
| ... | | |
| } | | |
| TCI-State ::= SEQUENCE { | | |
| tci-StateId | TCI-StateId, | |
| qcl-Type1 | QCL-Info, | |
| qcl-Type2 | QCL-Info | OPTIONAL, - |
| - Need R | | |
| Expanded TCI-State | BIT STRING (SIZE (1)) | OPTIONAL, |

```
    ...
}
Another example for the TCI-structure could be:
Expanded-TCI-State ::= SEQUENCE {
  tci-StateId TCI-StateId
  qcl-Type1_1 QCL-Info // first QCL-TypeA/B/C RS
  qcl-Type1_2 QCL-Info // second QCL-TypeA/B/C RS
  qcl-Type2_1 QCL-Info // first QCL-TypeD RS
  qcl-Type2_2 QCL-Info // second QCL-TypeD RS
...
}
```

Other implementations for providing the information of the expanded TCI-state for aperiodic NZP-CSI-RS with repetition ON, could be used in other examples.

FIG. 3B shows a method corresponding to the method of FIG. 3A. The example method of FIG. 3B could be performed by a UE 110. The UE 110 could be a smartphone or any other suitable type of UE 110. The UE 110 can be configured to communicate with an access node 120 that performs the method shown in FIG. 3A. The UE 110 could be in a network 100 as shown in FIG. 1 or any other suitable type of network. The UE 110 that performs the method of FIG. 3B is the UE 110 from which the access node 120 receives the report at block 301. The UE 110 can be configured to identify at least a primary access node 120 beam configuration and an availability of one or more secondary beam configurations wherein the primary beam configuration and the secondary beam configuration comprise different angular areas from which the UE 110 receives power from the node apparatus 120. For example, the UE 110 can be configured to identify a P-APA and an SU-APA.

At block 305 the method comprises receiving information indicative of at least one expanded transmission configuration from a node apparatus. The node apparatus could be an access node 120 or any other suitable type of node apparatus. The node apparatus could be a node apparatus that has performed the method of claim 3A.

The information indicative of the at least one expanded transmission configuration can be received in response to a report transmitted by the UE 110 indicating at least the primary beam configuration and an availability of one or more secondary beam configurations. For example, the UE 110 can transmit a report indicating any secondary access node 120 beam configurations that can be used to receive power by the UE 110. The transmitted report can indicate one or more access node 120 beam configurations that the UE 110 has determined to be receiving power above a threshold level.

The expanded transmission configuration comprises a primary beam configuration and a secondary beam configuration wherein the primary beam configuration and the secondary beam configuration comprise different angular areas from which the UE receives power from the node apparatus. The information indicative of at least one expanded transmission configuration that is received from the node apparatus can provide an indication of the primary beam configuration and/or the secondary beam configuration.

The information indicative of the at least one expanded transmission configuration can be received in any suitable format. For instance, the information indicative of the at least one expanded transmission configuration can comprise one or more bits in a pre-agreed structure within a message. The position and/or value of the bits in the message can provide an indication of the whether or not an expanded transmission configuration is available.

In some examples the at least one expanded transmission configuration can comprise an indication of a cell and a bandwidth part. The at least one expanded transmission configuration can enable the access node 120 to transmit Downlink (DL) signals using either the primary beam configuration combined with the secondary beam configuration. The at least one expanded transmission configuration can enable the

UE 110 to receive signals based on one or more QCL assumptions.

The at least one expanded transmission configuration can comprise one or more TCI-states or any other suitable type of transmission configurations.

In response to receiving the information indicative of the at least one expanded transmission configuration, the method comprises, at block 307, enabling the UE 110 to use the primary beam configuration and/or a secondary beam configuration to receive signals from the node apparatus. This can enable the UE 110 to use either primary access node 12 beam configuration alone to receive signals using the non-expanded transmission configuration or to use the primary and/or secondary beam configuration to receive signals using the expanded beam configuration. The primary beam configuration makes use of a P-APA and the secondary beam configuration makes use of an SU-APA.

FIG. 4 shows an example expanded transmission configuration. In this example the expanded transmission configuration is an expanded TCI-state.

FIG. 4 shows an access node 120 and a UE 110. The access node 120 and the UE 110 could be part of a network 100 such as the network 100 of FIG. 1. The UE 110 could be a smartphone or any other suitable type of UE 110. The access node 120 could be a gNB or any other suitable type of access node 120.

In the example of FIG. 4 the access node 120 is configured to transmit using a wider expanded beam configuration and the UE 110 is configured to receive using a narrow beam configuration. In these examples the access node 120 transmits using an expanded P1 like configuration and the UE 110 receives using a P3 configuration.

The access node 120 can be configured to transmit reference signals to the UE 110. For instance, the access node transmits an SSB (Synchronisation Signal Block) sweep. The SSB beam sweep can be transmitted in a plurality of different angular directions. The UE 110 can then measure Reference Signal Received Power (RSRP) values for the different SSBs. If two or more SSB indices are above a threshold power level and are received from different angular areas then this can be reported from the UE 110 to the access node 120. The SSBs can be considered to be received from different angular areas if they are determined to be received from different APAs. FIG. 6 shows an example that can be used to determine if signals are received from different APAs.

In the example of FIG. 4 the UE 110 has reported to the access node 120 that the UE 110 can received SSBs from different APAs. This indicates that a secondary beam configuration could be used to receive power from the access node 120. In response to this report the access node 120 has configured the expanded transmission configuration as shown in FIG. 4. The expanded transmission configuration as shown in FIG. 4 comprises a combination of the primary and secondary beam configurations as shown in FIGS. 2A and 2B.

In the example of FIG. 4 the expanded transmission configuration comprises a primary angular direction 401 which enables a beam to be transmitted directly from the access node 120 to the UE 110. This primary angular direction 401 is not reflected from any buildings and so may provide the highest power signal to the UE 110. The expanded transmission configuration also comprises an angular direction 403. The secondary angular direction is reflected from the building 203 towards the UE 110. Due to the reflection from the building 203 the UE 110 receives less power using the secondary angular direction 403 than using the primary angular direction 401.

Any suitable means can be used to provide the expanded transmission configuration. In examples where the expanded transmission configuration comprises an expanded TCI-state the access node 120 can expand the TCI-state of the primary TCI-state when configuring NZP-CSI-RS with repetition ON.

An expanded TCI-state can be enabled if the QCL assumption source can be constructed from multiple reference signals. For instance, if the UE 110 detects that there are two SSB beams that are received above a threshold level then the access node 120 can configure the QCL-Type D Reference Signal (RS) field with two SSBs instead of one.

The access node 120 can indicate the expanded TCI-state to the UE 110 using any suitable type of indication. In some examples the access node 120 can indicate the expanded TCI state by adding a single bit to the DCI associated with the primary TCI-state or by any other suitable means.

In some examples the access node 120 might also require one or more additional conditions to be satisfied before the expanded transmission configuration. Such conditions could be a time threshold since the last measurement of the reference signal

(RS), the applicability of the QCL assumptions or any other suitable criteria. The applicability of the QCL assumptions could be signaled explicitly. For instance, it could be provided as a bit in the DCI. For instance, if the time since the last measurement of the RS and/or the time since the last reporting of the RS is above a threshold then the second RS in the TCI-state providing the second QCL-Type D assumption is not valid.

In such cases the expanded transmission configuration would not be enabled.

The UE 110 can receive information indicative of the expanded transmission configuration. For example, the UE 110 can receive a CSI-ResourceConfig comprising one or more bits indicating whether or not an expanded transmission configuration is available. These bits could be as described above in relation to FIG. 3A or any other suitable message and format could be used.

The UE 110 will interpret an indication that an expanded transmission configuration is available as an acknowledgement from the access node 120, that it has received the indication of the alternative SSB beam that is received via a different APA at the UE 110.

When the UE 110 receives this indication the UE 110 can assume that the access node 120 uses a combined transmission beam of the first and second SSB as indicated in the report from the UE 110 for the DL transmission. The combined transmission beam comprises an expanded transmission configuration. The UE 110 can configure separate beams that each will cover the APAs included in the expanded transmission configuration. That is a first UE 110 beam can cover the primary access node 120 beam configuration 401 and a second UE 110 beam can cover the secondary access node 120 beam configuration 403. In the example of FIG. 4A the UE 110 can configure beams that each will independently cover the primary and the alternative SSB beam when sending aperiodic NZP-CSI-RS with repetition ON.

In examples of the disclosure the access node 120 is in control of whether or not the expanded transmission configuration is used. The access node 120 can decide whether or not the expanded transmission configuration is used based on requirements such as the reliability and robustness of communication that is needed. The access node 120 might decide not to use the expanded transmission configuration if a higher antenna gain is needed due to poor channel conditions or for any other suitable reason.

If the access node 120 decides not to use the expanded transmission configuration this can be indicated to the UE 110. For example, if the access node 120 decides not to use the alternative SSB beam for aperiodic NZP-CSI-RS with repetition ON the bit value #0 would be used in the messages as described above.

Examples of the disclosure therefore provide the benefit that the access node 120 can enable the UE 110 to align beams toward a plurality of different access node 120 beam configurations within the expanded transmission configuration wherein the different beam configurations are received from different angular areas. In examples, the UE 110 can align a first beam configuration towards a primary beam configuration and a second beam towards the secondary beam configuration. This additional UE 110 beam alignment does not require any additional resources. This alignment also does not need the expanded transmission configuration to be initiated.

The examples of the disclosure can therefore enable the alternative beam configuration to be P1 (wide beam) aligned at the access node 120 and P3 (Narrow beam) aligned at the UE 110 with no additional resources. If the access node 120 decides to switch to the secondary beam configuration it can quickly set up the transmission configuration or TCI-state for that beam configuration because the angular direction is known and the UE 110 is already P3 aligned. To enable the full alignment the access node 120 only need to perform CSI beam refinement (P2).

FIG. 5 shows an example signaling chart that can be used in examples where the UE 110 has the capability to report APAs. For example, the UE 110 could report a P-APA and one or more SU-APAs. The signaling chart shows a method that can be implemented by a system comprising a UE 110 and an access node 120 such as a gNB. The UE 110 and the access node 120 can be within a network 100 such as the network 100 of FIG. 1 or any other suitable type of network.

At block 501 the access node 120 and the UE 110 configure the UE 110 in an RRC connected state. Any suitable process can be used to configure the UE 110 in the RRC connected state.

At block 503 the UE 110 transmits a report indicative of the UE 110 capabilities to the access node 120. This report can indicate the format or data structure that will be used to report that the UE 110 is able to characterize if SSBs are received from different directions and above a threshold level. Other types of reporting or information could be used in other examples of the disclosure.

At block 505 the UE 110 sends the SSB report to the access node 120. In this example the SSB report can report that the UE 110 can receive more than one SSB above a threshold power level and that these SSBs can be received from different directions. For instance, the UE 110 can report the availability of one or more SU-APAs. In some examples the UE 110 could indicate the SSB Indices and the APAs associated with the indices.

At block 507 the access node 120 can evaluate whether an expanded TCI-state is needed. For examples the access node 120 can determine if an expanded TCI-state for aperiodic CSI-RS with repetition “ON” is needed. The access node 120 can base this evaluation on the SSB report that is received from the UE 110 at block 505, the Channel Quality Indicator (CQI) of the current active link between the UE 110 or any other suitable factor.

At block 509 the access node 120 prepares a beam configuration that covers both the angular directions of a primary beam configuration and a secondary beam configuration. The primary beam configuration can be the active SSB and the secondary beam configuration can be the alternative SSB beam that is reported by the UE 110 at block 505. The beam configuration covers the spatial domain of both the active SSB beam, or CSI beam, and the alternative SSB beam that is reported by the UE 110 at block 505.

At block 511 the access node 120 allocates resources for the expanded transmission configuration. In this example the access node 120 allocates resources for aperiodic CSI-RS with repetition “ON”. The access node 120 can also indicated to the UE 110 that the resources have been allocated. Any suitable means can be used to indicate to the UE 110 that the resources have been allocated. In some examples, the indication of the access node 120 configuring an expanded TCI-state can be added to such messages to the UE 110 by a simple added bit setting.

At block 513 the access node 120 indicates the allocation for the expanded configuration state to the UE 110. At block 515 the access node 120 transmits using the expanded TCI-state. The access node 120 transmits an aperiodic CSI-RS with repetition “ON” using the expanded TCI-state.

At block 517 the UE 110 can decide whether to use the angular direction of the primary access node 120 beam configuration or the angular direction of the secondary access node 120 beam configuration. In this example the UE 110 can decide whether or not to do P3 beam alignment on the active SSB beam and/or on the alternative SSB beam that was reported by the UE 110 at block 505. Whether or not the UE 110 activates one link or two can depend on the hardware capabilities of the UE 110.

In some examples of the disclosure the UE 110 can determine whether or not reference signals from the access node 120 are received from different APA or from the same APA. If different APAs are used then if the signals received from this APA are above a threshold level they can be considered to be SU-APAs. FIG. 6 shows an example method for determining whether or not one or more SU-APAs are available. The example method of FIG. 6 could be performed by a UE 110. The UE 110 could be a smartphone or any other suitable type of UE 110.

At block 601 the method comprises activating a first set of receivers of the UE 110, where a set of receives could be one or multiple. The set of receivers could be one or multiple of the panels or beams within the UE 110.

At block 603 a reference signal is received by the UE 110 and measured. The received power levels of the reference signal could be measured. The reference signal can be any suitable type of reference signal. For instance, the reference signal could be an SSB signal or a CSI-RS signal.

The measured signal values could comprise the received power levels of the reference signal or any other suitable type of values. For example, the measured signal values could comprise the RSRP values or any other suitable type of values.

The measured signal values are stored at block 605. The measured signal values can be stored so that they can be used to compare different signals at a later point in time. The measured signal values can be stored so that they can be used to compare different signals after all of the reference signals have been received and measured. The measured signal values can be stored in a memory of the UE 110 or in any other suitable storage location.

At block 607 it is determined whether or not all of the expected reference signals have been measured. If all of the signals have not been measured then the process moves to block 609 and the next reference signal is measured. Once the next reference signal has been measured the process returns to block 605 to store the measured value.

If, at block 607, it is determined that all of the expected reference signals have been measured then the process moves to block 611 and it Is determined whether or not all receivers have been used.

If all of the receivers have not been used then the process moves to block 613 and the next receiver is activated. Once the next has been activated the process returns to block 603 to measure the reference signals that have been received by the next receiver.

If, at block 611, it is determined that all of the receivers have been used then the process moves to block 615 and relative signal values are determined.

Any suitable process can be used to determine the relative signal values. The relative signal values can comprise the difference in the power levels for a given reference signal received on the different receivers. For example, the relative signal values could comprise the differences in the RSRP values for a given SSB index for each of the receivers.

In some examples the method can comprise generating a vector for at least some of the received reference signals. The values within the vector can comprise reference signal receive power (RSRP) values for two or more the receivers used.

At block 617 the relative signal values can be compared. This enables the relative signal strengths of the received signals to be compared. In some examples this can be comparing the vectors that might formed at block 615.

Reference signals can be classed as being from the same APA if they have differences that are similar to each other. For instance, two or more vectors can be compared and if they are within a threshold of each other the reference signals corresponding to the vectors can be considered to be received from the same APA. However, if the vectors are not within a threshold of each other then the reference signals can be classed as being from different APAs.

In some examples the method can comprise grouping reference signals to different APAs. Reference signals with similar differences between measured values can be classified together in the same group. This grouping can be used to identify which reference signals have been received by a P-APA and which have been received by an SU-APA.

If it is determined that the reference signals are received from different APAs then a P-APA and one or more SU-APAs can be identified based on received power levels or any other suitable criteria.

The APAs do not need to be defined precisely. That is, the angular ranges covered by the APAs do not need to be determined either in absolute terms or relative terms. It is sufficient to identify that a P-APA is different from an SU-APA. This can enable the P-APA and the SU-APA to be identified without any known and/or pre-characterized spatial filtering at the UE 110. This can enable the UE 110 to identify the P-APA and the SU-APA in any conditions, including conditions in which the users' hands are blocking one or more panels of the UE 110.

In the example of FIG. 6 the reference signals have been received sequentially. In other examples the reference signals could be received simultaneously, or substantially simultaneously.

Examples of the disclosure therefore provide the increased robustness and/or reliability for communications between a UE 110 and an access node 120 because the access node 120 is made aware of an SU-APA. The SU-APA can be associated with an SSB beam index so that the access node can use this information to set up an expanded transmission configuration.

Examples of the disclosure also provide for a short time for finding and setting up the expanded transmission configuration because the access node 120 can already be informed of the one or more SU-APAs that could be used. There is no need for any more expanded reference signals to be transmitted by the access node 120 in order to find the SU-APAs.

FIG. 7 illustrates an example of a controller 700. The controller 700 could be provided within an apparatus such as a UE 110 or a gNB. Implementation of a controller 700 may be as controller circuitry. The controller 700 may be implemented in hardware alone, have certain aspects in software including firmware alone or can be a combination of hardware and software (including firmware).

As illustrated in FIG. 7 the controller 700 can be implemented using instructions that enable hardware functionality, for example, by using executable instructions of a computer program 706 in a general-purpose or special-purpose processor 702 that may be stored on a computer readable storage medium (disk, memory etc.) to be executed by such a processor 702.

The processor 702 is configured to read from and write to the memory 704. The processor 702 may also comprise an output interface via which data and/or commands are output by the processor 702 and an input interface via which data and/or commands are input to the processor 702.

The memory 704 stores a computer program 706 comprising computer program instructions (computer program code) that controls the operation of the apparatus when loaded into the processor 702. The computer program instructions, of the computer program 706, provide the logic and routines that enables the apparatus to perform the methods illustrated in FIGS. 3 to 6 The processor 702 by reading the memory 704 is able to load and execute the computer program 706.

In examples where the controller 700 is provided within a UE 110 the controller 700 therefore comprises: at least one processor; and at least one memory including computer program code; the at least one memory and the computer program code configured to, with the at least one processor, cause the apparatus at least to perform;
receiving information indicative of at least one expanded transmission configuration from a node apparatus wherein the expanded transmission configuration comprises a primary beam configuration and a secondary beam configuration wherein the primary beam configuration and the secondary beam configuration comprise different angular areas from which the UE receives power from the node apparatus; and
in response to receiving the information indicative of the at least one expanded transmission configuration enabling the UE to use the primary beam configuration and/or the secondary beam configuration to receive signals from the node apparatus.

In examples where the controller 700 is provided within an access node 120 the controller 700 therefore comprises: at least one processor; and at least one memory including computer program code; the at least one memory and the computer program code configured to, with the at least one processor, cause the apparatus at least to perform;
receiving a report from a User Equipment (UE) indicating at least a primary beam configuration and an availability of one or more secondary beam configurations wherein the primary beam configuration and the secondary beam configuration comprise different angular areas from which the UE receives power from the node apparatus; and
in response to receiving the report enabling at least one expanded transmission configuration based, at least in part, on the availability of the one or more secondary beam configurations wherein the expanded transmission configuration comprises the primary beam configuration and a secondary beam configuration.

The computer program 706 may arrive at the apparatus or network apparatus via any suitable delivery mechanism 708. The delivery mechanism 708 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 706. The delivery mechanism may be a signal configured to reliably transfer the computer program 706. The apparatus may propagate or transmit the computer program 706 as a computer data signal.

The computer program 706 can comprise computer program instructions for causing a UE 110 to perform at least the following or for performing at least the following:
receiving information indicative of at least one expanded transmission configuration from a node apparatus wherein the expanded transmission configuration comprises a primary beam configuration and a secondary beam configuration wherein the primary beam configuration and the secondary beam configuration comprise different angular areas from which the UE receives power from the node apparatus; and
in response to receiving the information indicative of the at least one expanded transmission configuration enabling the UE to use the primary beam configuration and/or the secondary beam configuration to receive signals from the node apparatus.

The computer program 706 can comprise computer program instructions for causing an access node 120 to perform at least the following or for performing at least the following:
receiving a report from a User Equipment (UE) indicating at least a primary beam configuration and an availability of one or more secondary beam configurations wherein the primary beam configuration and the secondary beam configuration comprise different angular areas from which the UE receives power from the node apparatus; and
in response to receiving the report enabling at least one expanded transmission configuration based, at least in part, on the availability of the one or more secondary beam configurations wherein the expanded transmission configuration comprises the primary beam configuration and a secondary beam configuration.

The computer program instructions may be comprised in a computer program, a non-transitory computer readable medium, a computer program product, a machine readable medium. In some but not necessarily all examples, the computer program instructions may be distributed over more than one computer program.

Although the memory 704 is illustrated as a single component/circuitry it may be implemented as one or more separate components/circuitry some or all of which may be integrated/removable and/or may provide permanent/semi-permanent/dynamic/cached storage.

Although the processor 702 is illustrated as a single component/circuitry it may be implemented as one or more separate components/circuitry some or all of which may be integrated/removable. The processor 702 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions and
(c) hardware circuit(s) and or processor(s), such as a microprocessor(s) or a portion of a microprocessor(s), that requires software (e.g. firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The stages illustrated in FIGS. 3 to 6 can represent steps in a method and/or sections of code in the computer program 706. The illustration of a particular order to the blocks does not necessarily imply that there is a required or preferred order for the blocks and the order and arrangement of the block may be varied. Furthermore, it can be possible for some blocks to be omitted.

Where a structural feature has been described, it may be replaced by means for performing one or more of the functions of the structural feature whether that function or those functions are explicitly or implicitly described.

In some but not necessarily all examples, the UE 110, and the network 100 are configured to communicate data with or without local storage of the data in a memory 704 at the UE 110, or the access nodes 120 and with or without local processing of the data by circuitry or processors at the UE 110, or the access nodes 120.

The data may be stored in processed or unprocessed format remotely at one or more devices. The data may be stored in the Cloud.

The data may be processed remotely at one or more devices. The data may be partially processed locally and partially processed remotely at one or more devices.

The data may be communicated to the remote devices wirelessly via short range radio communications such as Wi-Fi or Bluetooth, for example, or over long range cellular radio links. The apparatus may comprise a communications interface such as, for example, a radio transceiver for communication of data.

The UE 110 and/or the network 100 can be part of the Internet of Things forming part of a larger, distributed network.

The processing of the data, whether local or remote, can be for the purpose of health monitoring, data aggregation, patient monitoring, vital signs monitoring or other purposes.

The processing of the data, whether local or remote, may involve artificial intelligence or machine learning algorithms. The data may, for example, be used as learning input to train a machine learning network or may be used as a query input to a machine learning network, which provides a response. The machine learning network may for example use linear regression, logistic regression, vector support machines or an acyclic machine learning network such as a single or multi hidden layer neural network.

The processing of the data, whether local or remote, may produce an output. The output may be communicated to the UE 110, and the access nodes 120 where it may produce an output sensible to the subject such as an audio output, visual output or haptic output.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1. A User Equipment (UE) comprising:
at least one processor; and
at least one memory including computer program code
the at least one memory and the computer program code configured to, with the at least one processor, cause the UE at least to perform:
receiving information indicative of at least one expanded transmission configuration from a node apparatus wherein the expanded transmission configuration comprises a primary beam configuration and a secondary beam configuration wherein the primary beam configuration and the secondary beam configuration comprise different angular areas from which the UE receives power from the node apparatus; and
in response to receiving the information indicative of the at least one expanded transmission configuration enabling the UE to use the primary beam configuration and/or the secondary beam configuration to receive signals from the node apparatus.

2. The UE as claimed in claim 1 wherein the information indicative of the at least one expanded transmission configuration is received in response to a report transmitted by the UE indicating at least the primary beam configuration and an availability of one or more secondary beam configurations.

3. The UE as claimed in claim 2 wherein the transmitted report indicates one or more beam configurations that the UE has determined to be receiving power above a threshold level.

4. The UE as claimed in claim 1 wherein the primary beam configuration makes use of a Primary-Angular Power Area (P-APA) and the secondary beam configuration makes use of a Secondary Useable-Angular Power Area (SU-APA) wherein an angular power area comprises a range of angular directions from which the UE is receiving power from the node apparatus.

5. The UE as claimed in claim 1 wherein the at least one expanded transmission configuration is indicated by using one or more bits in a pre-agreed structure within a message.

6. The UE as claimed in claim 1 wherein the at least one expanded transmission configuration comprises an indication of a cell and a bandwidth part.

7. The UE as claimed in claim 1 wherein the at least one expanded transmission configuration enables the node apparatus to transmit Downlink (DL) signals and/or enables the UE to receive signals based on one or more Quasi Co-Location (QCL) assumptions.

8. The UE as claimed in claim 1 wherein the at least one expanded transmission configuration comprises one or more Transmission Configuration Indicator (TCI) states.

9. A method comprising:
receiving information indicative of at least one expanded transmission configuration from a node apparatus wherein the expanded transmission configuration comprises a primary beam configuration and a secondary beam configuration wherein the primary beam configuration and the secondary beam configuration comprise different angular areas from which the UE receives power from the node apparatus; and
in response to receiving the information indicative of the at least one expanded transmission configuration enabling the UE to use the primary beam configuration and/or the secondary beam configuration to receive signals from the node apparatus.

10. (canceled)

11. A node apparatus comprising:
at least one processor; and
at least one memory including computer program code,
the at least one memory and the computer program code configured to, with the at least one processor, cause the node apparatus at least to perform:
receiving a report from a User Equipment (UE) indicating at least a primary beam configuration and an availability of one or more secondary beam configurations wherein the primary beam configuration and the secondary beam configuration comprise different angular areas from which the UE receives power from the node apparatus; and
in response to receiving the report enabling at least one expanded transmission configuration based, at least in part, on the availability of the one or more secondary beam configurations wherein the expanded transmission configuration comprises the primary beam configuration and a secondary beam configuration.

12. A The node apparatus as claimed in claim 11 wherein the received report indicates one or more beam configurations that the UE has determined to be receiving power above a threshold level.

13. A The node apparatus as claimed in claim 11 wherein the primary beam configuration makes use of a Primary-Angular Power Area (P-APA) and the secondary beam configuration makes use of a Secondary Useable-Angular Power Area (SU-APA) wherein an angular power area comprises a range of angular directions from which the UE is receiving power from the node apparatus.

14. A The node apparatus as claimed in claim 11 wherein the at least one processor and at least one memory are configured to perform transmitting information indicative of the at least one expanded transmission configuration to the UE.

15. A The node apparatus as claimed in claim 11 wherein the at least one expanded transmission configuration is indicated by using one or more bits in a pre-agreed structure within a message.

16. A The node apparatus as claimed in claim 11 wherein the at least one expanded transmission configuration enables the node apparatus to transmit Downlink (DL) signals and/or enables the UE to receive signals based on one or more Quasi Co-Location (QCL) assumptions.

17. A The node apparatus as claimed in claim 11 wherein the at least one expanded transmission configuration comprises one or more Transmission Configuration Indicator (TCI) states.

18. A The node apparatus as claimed in claim 11 wherein the at least one expanded transmission configuration is enabled based on one or more requirements of the node apparatus.

19-20. (canceled)
